(19) United States
(12) Patent Application Publication
(10) Pub. No.: US 2011/0137854 A1
(43) Pub. Date: Jun. 9, 2011

(54) SYSTEM FOR THE MANAGEMENT OF FILES

(76) Inventor: Thomas Walter, Eschborn (DE)

(21) Appl. No.: 13/057,749

(22) PCT Filed: Jul. 24, 2009
(86) PCT No.: PCT/IB09/06359

§ 371 Date: Feb. 4, 2011

(51) Int. Cl. G06F 17/30

(52) U.S. Cl. 707/608; 707/E17.032

(57) ABSTRACT

The invention concerns a system and a procedure for the administration of files by using electronical data processing equipment that are connected with each other by a network. In order to provide a unitary system to solve all modern office- and communication tasks instead of using a multitude of programs, systems and devices, it is suggested with the invention that at least one data processing installation features a user-related container file system whose function is based on the fact that the files of a particular user are collected into one single data file, wherein the access to the files of the data file occurs depending on access rights and wherein an automatic comparison of the data files with a replica existent within the system is being performed.

### INTRODUCTION

The invention presented concerns a system and a procedure for the management of files through the application of data processing facilities electronically connected with each other by means of a network.

In the spirit of the patent application presented, the files may have various formats and, for example, be comprised of either whole application programs for electronic data facilities or composites consisting of one or more files, whereby the files may contain any informational content desired.

Pertaining to the current state of technology, the fact that documents are managed by means of databases on electronic data processing equipment is known. A variety of databases, such as relational, object-oriented or full text databases are used for this purpose for various fields of application, or a combination of various databases may be used. Independent of the type of database used, they provide the advantage of having comprehensive access and management mechanisms, by means of which the documents and references stored in them may be managed in a timely and comfortable manner. One other possibility is the management of the documents by means of electronic data processing facilities using a file system, which is well-known today and widely used in accordance with the current state of technology.

Modern office work is no longer comprehensible without the usage of computers, since a large amount of today's office work occurs using a multitude of programs and systems on computers. In accordance with this, a correspondingly modern work environment includes, for example, a computer or notebook, which has been equipped with an operating system, certain application programs for word processing, etc., as well as an appropriate email client, in combination with copiers, fax devices, telephones, cell phones, file folders and filing cabinets.

In order to be able to guarantee an effective business environment, one first requires an appropriate means of communication, whereby, for example, business partners may be contacted by telephone, or meetings may be agreed upon between secretarial services. Important contractually-binding documents and contracts are generally sent in advance via facsimile devices. Furthermore, one needs an appropriate email system for the exchange of information, arrangements for appointments and documents. Corresponding document storage generally uses folders, hanging folder systems or boxes. In addition, meetings are required, which generally take place on the personal level and imply large expenditures in terms of travel and costs.

Once a company achieves a moderate size, an expensive IT infrastructure becomes necessary. This includes, for example, email clients, data and file storage, which has generally been provided by means of local or network hard disks on file servers (home directories, project-specific drives, etc.), virus and spam filters (generally, a company-owned server), a firewall, Internet security (generally, a proxy server), customer relations management systems (CRM), a means of registering time worked, inventory, vacation databases, project databases, conference systems, telephone facilities and devices, interconnection between sites (WAN infrastructure), data centers with emergency power supplies, fire protection, climate control, security arrangements and access protection, servers, storage, network infrastructure, backup, restore and disaster recovery equipment (branding robots, etc.) The procurement, operation and maintenance of a correspondingly secure and efficient IT infrastructure are extremely time and costs intensive. Maintenance of the services requires highly-qualified employees. This is extremely complicated for smaller businesses. Such companies require very efficient IT environments, in order to be able to chart growth on the one hand, while on the other hand, these requirements cannot be financially charted. Exactly these problems have caused many companies to fail.

Today, most of the expertise of a company is concentrated in the employees' email traffic. However, for reasons of technology and expense, most of the companies are very heavily limited here. The number of email messages and the size of email accounts are therefore limited. This leads to the fact that most employees store their data locally on the hard disks of their computers or on CD's or DVD's. Thus, the data can be lost to the company and, at the latest, when an employee leaves, company information may fall into the hands of others. Until now, an integrated technological solution for this problem has not been available. In addition to this, all of the current email systems are standalone systems with only minimal integration into the remaining IT infrastructure. These systems generally use proprietary data formats incompatible with the remaining IT infrastructure.

In general, business correspondence, proposals, etc. are created by means of a word processing program, stored and sent as email attachments to an email to employees worldwide. Depending upon whether any potential changes to these documents have been made, new versions are returned. Each email is forwarded with all attachments, which is extremely inefficient. Above all else, in addition to technological resource mismanagement, time and productivity are wasted in doing so. Every employee must read the entire history, store all attachments and open and examine them for any changes. This approach lengthens processing time and increases version conflicts.

Files are stored on the local computer (PC) or notebook. The networks, home directories, etc. provided by the company are often used only for the “official” data. In doing so, employees concentrate their expertise on work environments controlled by them. Thus, a given company has no options for addressing this data, or even its contents. When an employee leaves, or the local computer has technical malfunctions, all of the employee's knowledge is ultimately lost to the company. Even if file servers were regularly used, these systems would have important disadvantages. Initially, this includes an unmanaged and generally chaotic organization of storage in the system. Furthermore, annual growth rates in data cause cost explosions of up to 80% in data storage. Duplicates of documents, such as for example, board presentations, are stored a thousand fold, which is likewise inefficient. The contents of digital documents, and the expertise connected with them, are extremely difficult to recover, if that is even possible, because content searches, reasonable document indices, different networks and different operating systems, are not available. Access does not exist due to the variety of document servers, and/or access is not allowed due to poor management of rights. Furthermore, a security risk exists given conventional system, since each IT administrator can access, purloin or even manipulate all of the data. Networked document sharing is limited to local networks. Access is only possible across networks shared in common (e.g. VPN). However, this requires effort and carries risks, since other data is endangered, and legal considerations often exist. Also, the centralized administration of conventional systems, where IT administrators attempt to control and maintain all access and rights centrally, is generally inefficient. Because of the enormously high costs in terms of personnel, this cannot be organizationally charted once a system has achieved a certain size. In addition to this, the dynamic intensity of an IT environment would be heavily inhibited by such measures. As a result, the employees again store all of the relevant data locally, and the network drives are, at best, used for archiving or storage.

### DESCRIPTION INVENTION

Given this background, the task of the invention presented is the distribution of a unified system for the resolution of all modern office and communication tasks in place of a multitude of programs, systems and devices.

This task is solved by a system in accordance with requirement 1 and a procedure in accordance with requirement 13, whereby a data processing facility features a user-oriented Container File System, whose purpose is based on the fact that any given user's files are collected into a single data file, whereby access to the files within this data file depends upon access rights and whereby an automated comparison of the data file is performed with a replicate located on one system.

According to the invention, the files of a given user have been collected into a Container File System, whereby such action can occur independent of the respective file format. In particular, such files may include emails, faxes, calendars, workflows or databases, which may all be stored using any file structure desired.

In accordance with the invention, not only are all types of files, data and documents securely addressable at the global level, but so are all necessary applications and services, which are required for an effective working environment. Overall, expanded office, communication and collaboration features have been collected by the invention on the basis of a new type of data management into a unified universal system. In doing so, attempts are made to meet the requirements of the operator without the technological limitations known at this time. The basis for this is the data management system, which focuses on the storage of, locating of and sharing (to share) of contents (contents).

The system would preferably possess a replication mechanism, which permits the distribution of replicates of the data files. These replicates permit ultimate data security, because it remains possible to continue working immediately after a new procurement or exchange in the event of loss or defect of any given PC. After a single notification to the Internet portal of the system's service provider, all programs and data are immediately available once more on the local PC. It does not matter for this, which operating system is used on the local PC, so long as the operating system has access to a web browser. If the usage of a given client is preferred, this client would automatically replicate the data files on the local hard drive or storage system preferably after installation. After this Container File System has been “mounted”, the respective operating system operates with a corresponding file system and has access to all of the data once more. The Container File System enables the collection of all relevant data. Even data from incompatible systems may be mutually shared from this storage location. Since this Container File System would preferably be based upon a database, current database systems would also be able to store their data records in a native mode by means of this Container File System. In addition to this, the system according to the invention would preferably provide a configurator (wizard) with pre-configured database templates (templates), which would enable the creation and adjustment of its own database application without the installation of additional software, such as for example, vacation databases, knowledge databases, etc.

An efficient, economically-priced and simple-to-use system of communication, which would be globally useable independent of the computer, operating system, programs, etc. in use, would be enabled by the system according to the invention. One single tool would be preferable for doing this instead of several tools, which could fulfill at least 80% of the needs of the daily office work, for which at least two of several application programs stored on provider application servers are combined with each other and thus are able to be presented as a single application program. Preferably, this single application would be useable without any training expense by means of a very simple user interface, and would feature a universal user interface and networked program features. However, as an alternative to this, well-known application programs, such as word processing software, etc., could be used. A very simple and minimalist IT infrastructure would be created by the invention, whose operation would be possible without IT personnel. This single application would be executable on all popular operating systems, thin clients and smart phones. Minimum requirements would be the existence of a web browser with an Internet connection. Each user should have the option of being able to access the entire working environment, to which they are accustomed, independent of location and technical equipment, at any time. This includes all applications, services and operating system services, including telephone, fax, e-letters, etc. The user can always securely access and process their real data from anywhere. The system would also provide the ability to save 75% of all travel expenses by means of powerful, integrated collaboration tools.

A user interface adjusted to the desktop metaphor can be provided with the following characteristics. A preview feature represents file contents as icons, for example, on the right side of the user interface, and a directory tree structure might be presented on the left side of the user interface. Files could be stacked and a tool suite, including editors for plain text, picture, audio and video files, might permit all of the file formats (PDF, TIF, DOC, JPEG, MPG) to be processed. Even DMS (database management system) tools, such as a date-received stamp, could be executed. New documents could be scanned by pressing a button on the scanner, for which a powerful scanner interface would be useful. The transmission of files, printing, faxing or sending documents by email may occur simply by means of Drag-n-Drop. Shares can be issued and revoked, whereby it can also be planned that all shares are limited by time and certificate and may be correspondingly listed. Furthermore, settings related to OCR, full text, the awarding of rights, email, calendars, etc., could be made. Additional operational procedures are planned, by means of which an operational procedure engine would provide the ability to graphically design, test, and if desired, implement simple operational procedures. In this sense, databases are likewise files and may be created, modified and administered. Furthermore, it is possible to create rights structures and user group management. Moreover, the creation, deletion, duplication, relocation, revision and comparison of files are possible.

Automated adjustment of the older version of a data file to the newer version of the same is executed in accordance with an expedient definition of the invention according to the understanding of the differences between the replicate and the data file. Therefore, if a difference is discovered by the automated comparison of a data file with the replicate already present on the system, the older version of the data file can be updated, such that the current version of the data file is always available and differing version are not present on the system, which would heavily increase the amount of data and make the system more obscure. Preferably, the automated adjustment of the older version of the data file with the newer version of the same occurs subsequently, as ultimately the modification of the data file corresponding to the acknowledged difference is transferred through the network for the adjustment of the older version of the data file. The definition of the system according to the invention represents a drastic reduction of the data to be transferred. In this connection, the automated comparison would preferably occur at the bit level.

For the implementation of the prescribed functionality, complex IT environments, high financial expenditures in offices, hardware and software, as well as enormous personnel expertise for the operation and maintenance of the equipment are required. The invention presented offers, by comparison, an enormous increase in productivity in both the personal as well as the corporate domain. The outstanding savings in costs generated by the invention presented are generated in particular by the minimization of incidental travel expenses, the elimination of boarding expenses, the drastic reduction in telephone expenses (global fiat, direct dial, etc.), the elimination of complex proprietary IT environments including corresponding on-site support (whereby the IT budget can be reduced by 90%), the elimination of licensing fees for operating systems, applications, etc., and the elimination of expenses for private individuals. In doing so, the competitive chances of small companies, in comparison with global players with gigantic IT budgets and maximized infrastructures, are improved. The system according to the invention should, in particular, be available to private individuals and third-world countries. It provides absolute data security in data management and communication. The system according to the invention would also work without requiring computer expertise, always and everywhere, and is useable by technically inexperienced individuals or groups of people, such as senior citizens. The combination of core applications according to the invention into a single application is useable by private individuals, who would like to maintain contact with their families in foreign countries by means of telephony and/or video conferencing, as well as by business power users.

The system according to the invention has been equipped with features, which are comparable with those of conventional email programs. For example, conventional email programs could be used in their original form by means of a fat client or an email program made available by means of a web browser. What is new is that all emails can be treated like normal files, whereby it is possible, for example, to simply drag an email to a folder, which folder might also contain any other file format. This is enabled by the Container File System based upon a database.

As an additional feature, the system according to the invention would provide at least three methods of telephone usage each combinable with the other in any manner. This occurs directly from the web browser through the usage of a proprietary soft phone and/or through the usage of an IP telephone. These variations offer the same scope of features as conventional, market-leading telephone equipment, whereby when using a softphone, the features are dependent upon the softphone used. The following should be designated as additional capabilities of the telephone equipment used in the scope of the invention: conferences with up to 20 participants, call transfer (hold), call waiting, caller ID or optionally suppression or display of the exchange, call parking (also hold with announcement), CLIP display of the calling even using analog telephones, busy signal when busy, voice broadcast groups, DND (do not disturb) protection, Call Forward-To Number (call transferal), call forwarding when busy (CFBS), when not answering (CFNA) or continuously (CFIM), call forwarding to telephone, externally or by web browser, speed dial, internal/external/VOIP call transferal, PC-supported dialing (TAPI option), call from Outlook, internal/external/VOIP hunt groups, hold music (recorded announcement, usage of any MP3 files without limitation on the number, playable either randomly or sequentially), Click to Dial, CTI (missed calls: display of the caller name from the telephone book, any combination of terminal devices). Furthermore, a voicemail box is planned for each participant, whereby a web browser interface would be made available for administration and voicemail messages would be forwarded via email. Listening to and deleting voicemail messages is done by means of a web browser and internal or external inquiry by telephone. Moreover, data acquisition of conversations is planned, whereby, for example, telephone numbers, the duration of the conversation and extension lines would be recorded. Furthermore, the data acquired with regards to the conversations could be made anonymous and a reference to the extension line and subsequent transfer to bookkeeping software (in CSV format) could occur. In addition, Least Cost Routing is planned, which would include the usage of PSTN, ENUM, and the Internet as well as an update service for SIP providers. Furthermore, LCR can also be used PSTN, ENUM and Internet.

The following advantages would result from combination with the VOIP services. First of all, the implementation of global telephony free-of-charge becomes possible and fixed rates could be implemented for cell phone networks. Therefore, global roaming would be provided, whereby roaming charges would be eliminated, and high quality digital speech would also be provided. Individualized assignment of telephone numbers would also become possible and all of the characteristics of modern telephone equipment could be retained.

Facsimiles could be sent and received, and transmission could occur from any application by means of a printer driver and/or scanner. All facsimiles received could also be transmitted by email.

Furthermore, chat modes with people or groups become possible, for which the system would preferentially indicate the availability of people and groups as a feature.

Beyond this, e-letters could be transmitted globally directly from word processors or any other document as letters (in black-and-white or color) by means of a printer driver. In this connection, the recipient would automatically be read from the salutation by means of optical character recognition (OCR), for example. The e-letter could be received, as, for example, a corresponding mailbox would be setup by contract with office services there. Instead of letter forwarding, the letter could be automatically acquired electronically and transmitted electronically as well.

Web conferences allow conferencing with any person desired or with any size group of people, for which a standard web camera and conventional audio hardware could be used. Conferences could be planned by means of the calendar. Consequently, conferences could be held using any standard PC with an Internet connection, meaning with existing standard hardware. Teams could create and process files collaboratively without regard to their location, which would be particularly ideal for the development, presentation and publication of products, as well as for training sessions and continuing education. All of this would occur at an exceptionally high quality representation of video files and applications. In addition, excellent audio quality would be provided, and USB web and video cameras would be supported.

Conferences and meetings could be transmitted to any number of participants and videos could be simply played. All invited participants could see these videos in real-time. All films and videos released throughout the world could be watched, which in the case of the invention presented would not, as is conventionally done, involve a central database or system, but rather a decentralized distributed data medium. If desired, this video data could be made incapable of modification or duplication. All information copyright holders could also prohibit access retroactively at any time.

In particular, applications could be used collaboratively, which would permit files and documents to be created and processed cooperatively and independent of location. Any application running on a computer could be shared with a group of any size. The participants would not need to have this application installed. They might, however, use it and/or control it remotely control, assuming the corresponding rights exist. In particular, even a desktop could be used collaboratively and controlled remotely. Comments and/or annotations could be added in any application by means of whiteboard software. Even drawings of any type could be collaboratively drafted.

Preferably, the integration of conventional office application software would provided for, where each of these applications would be opened in their own tab page when using web browsers.

Personal and group calendars, as well as task planners, could also be given categories and project views. In addition, an outcome and project planner is planned, which would involve a novel type of time management. Tasks would no longer be used for planning, but rather results, outcomes and milestones. These outcomes could include a variety of tasks. The novelty lies in the fact that the tasks would no longer need to be defined. The goal would be oriented on the achievement of the desired result (milestone) alone. Necessary tasks could be delegated or distributed to individual people or groups. If the people or groups were to accept the assignment, they would be entered in the personal planner for those people or groups. Subsequently, each group member could decide for themselves which task they need to perform in order to achieve the results.

In particular, a project tracker is planned by means of which global projects could even be developed transparently across company boundaries.

The system would preferably include a contact database integrated with the features of a CRM (Customer Relation Management) system. Additional CRM features could be activated for each piece of contact information available. Thus, it would now be possible to record the course of conversations, to link files with contacts and to deposit in a hold file. Tasks sorted according to projects and priorities automatically would appear in the calendar and the task manager. A CRM view would enable assessments and preferably provide an interface for an external CRM solution. With this system, an automated comparison could take place. Contacts could be assigned to groups, such as family, friends, co-workers, etc. All of the contacts, who work with the system according to the invention, could display their status (online, absent, unavailable, offline, display as offline) to specified groups and individuals. This enables making contact quickly and without complication. All telephone numbers present in the system could be called by clicking on them. If the system has been configured for the usage of a softphone then the contact would be dialed immediately. If an external telephone or an external telephone device has been connected, the telephone would indicate a call. By picking up the receiver, the connection would be automatically made using the previously clicked telephone number. For each contact, a chat window, a web conference or a telephone conversation could also be started. Additionally, all available shares and resources would be displayed for each contact.

Furthermore, the system possesses a workflow-engine, whereupon it is suggested that simple project tracking-workflows already exist. With this workflow-engine, every kind of workflow can be clicked together by means of the wizard.

In addition, the use of a dashboard is suggested which is freely configurable and enables a simple compilation of analyses and views as well as a generation of alerts and notifications. That way one can (f. e.) show the occurrence of absences of colleagues or automatically send email-notifications, when favored results were not achieved in a destined time frame (escalation management).

Almost any application can be integrated (customization), and the system features pre-defined interfaces for data import/export as well as data interfaces for current inventory management.

Any given file (files, documents, calendar, tasks, outcomes, projects, data base etc.) can be de-allocated, which means that single users or groups can be chosen out of the address book or be entered manually, whereupon after a distribution of rights and the entering of a password a certificate is generated automatically, which can then be sent via email with a link to the particular person. If the invited persons also use the new aforementioned container file system, the new folder, for instance, appears under “de-allocated”. All rights of access as well as the public-certificates are replicated on a central data base for access authorizations (CARD). All de-allocated files can be but do not have to be replicated locally.

All of the security functions are preferably based on certificates. All data are preferably transferred and saved encrypted. An own certificate-engine calculates the necessary certificates (public, private) and saves these in the container file system as well as centrally in the CARD-data base. Via public certificates, rights can be distributed and removed globally.

If rights are removed, for example with the retirement of a colleague, his files become futile for him, even if he has a data copy. This new way of data management for businesses as well as private users makes it possible to protect the content of all files unrestrictedly against access of a third party. Without a valid certificate, the data cannot be accessed, not even by administrators or other persons. Thereby, privacy is guaranteed. The container file system, as further explained, saves merely a large data file that may also exist on public servers. The data files are not readable without a valid certificate and personal key. A high data encryption makes the access for unauthorized persons virtually impossible. Naturally, extended structures of rights can be displayed. For example, it is possible for businesses to access data from their co-workers and exclude these from their access. That way, intellectual property can be protected as well. Objects can only be viewed but not copied.

Further advantages and attributes of this given invention are displayed by the means of demonstration examples as shown in the following figures:

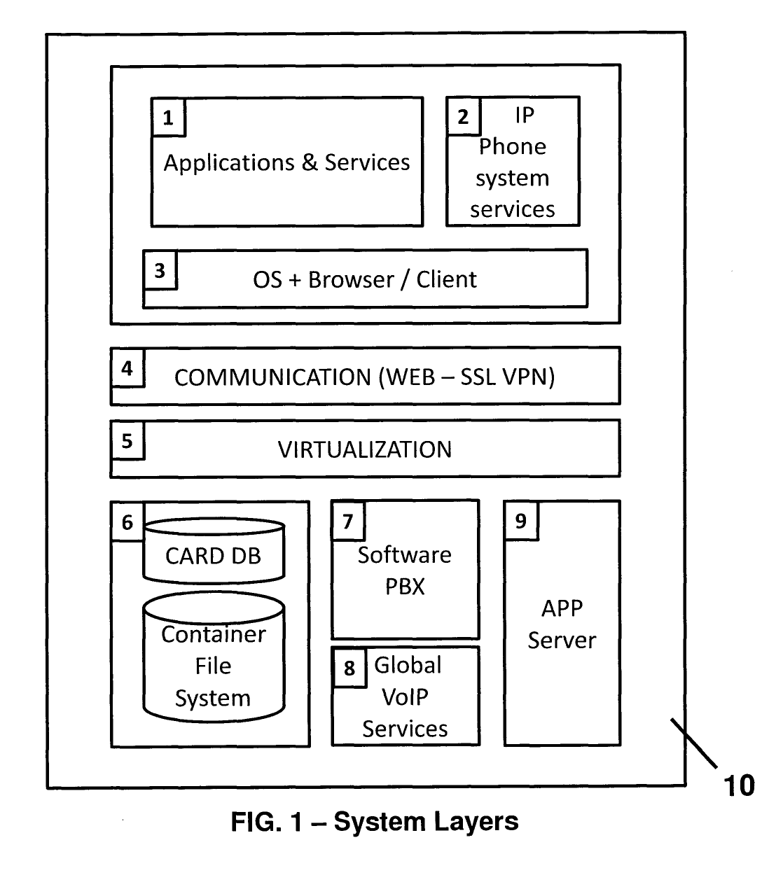

FIG. 1 a schematical demonstration of the system build-up

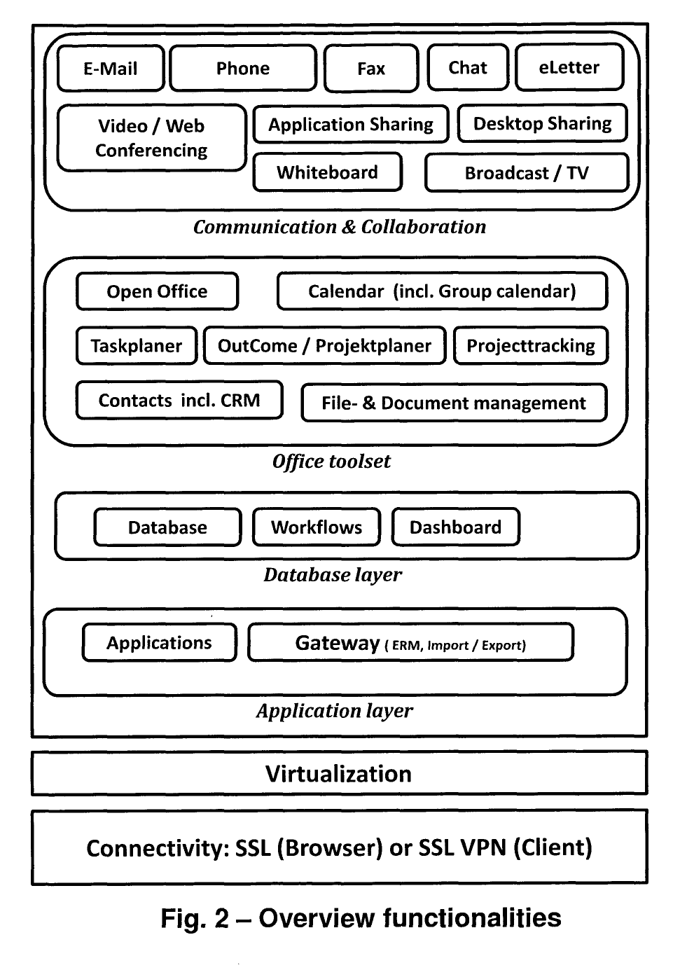

FIG. 2 an exemplary system overview of the virtualized applications and services

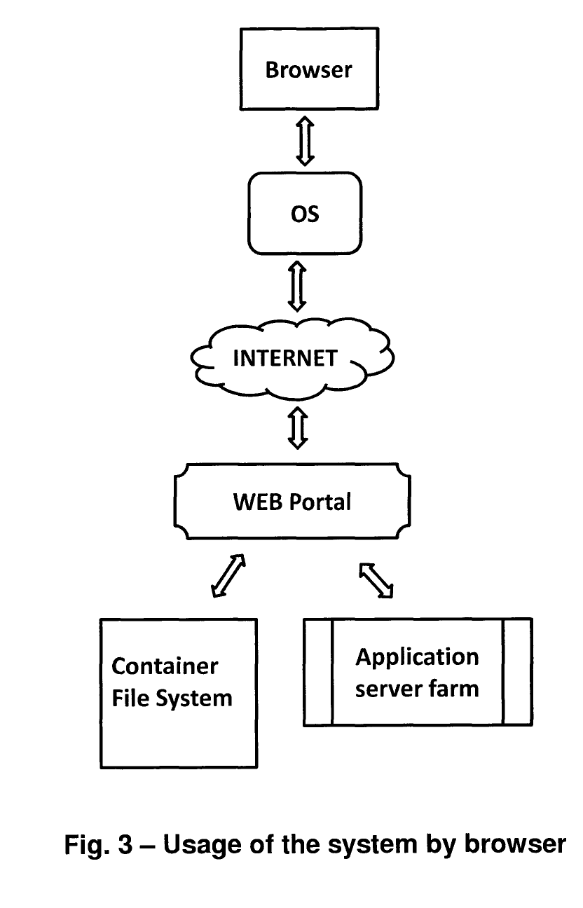

FIG. 3 a usage of the system by the means of a browser according to the invention

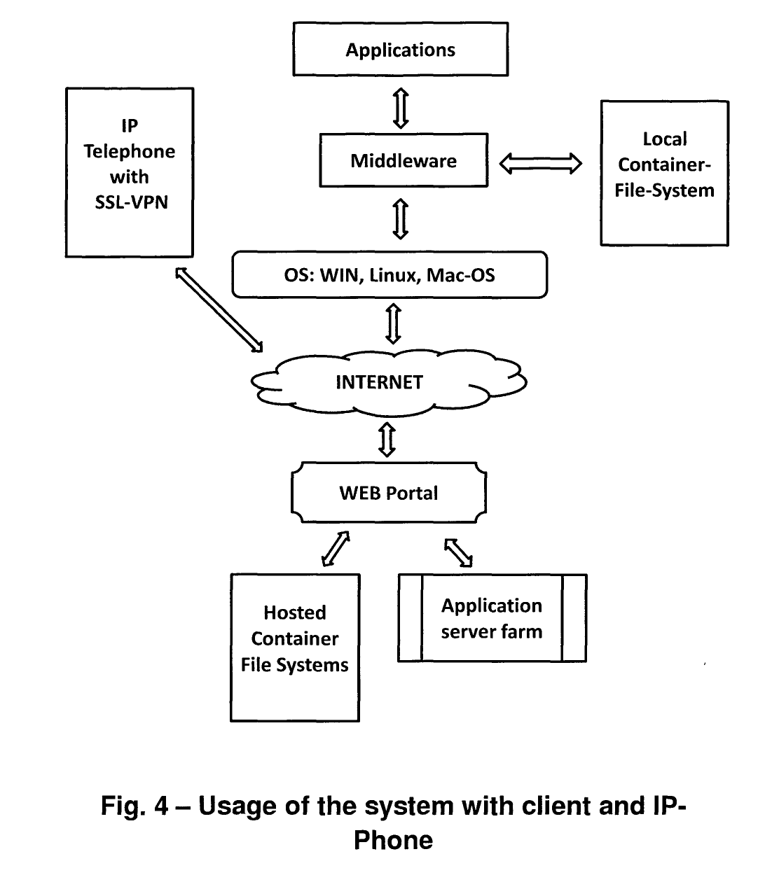

FIG. 4 the usage of the system by the means of a client according to the invention

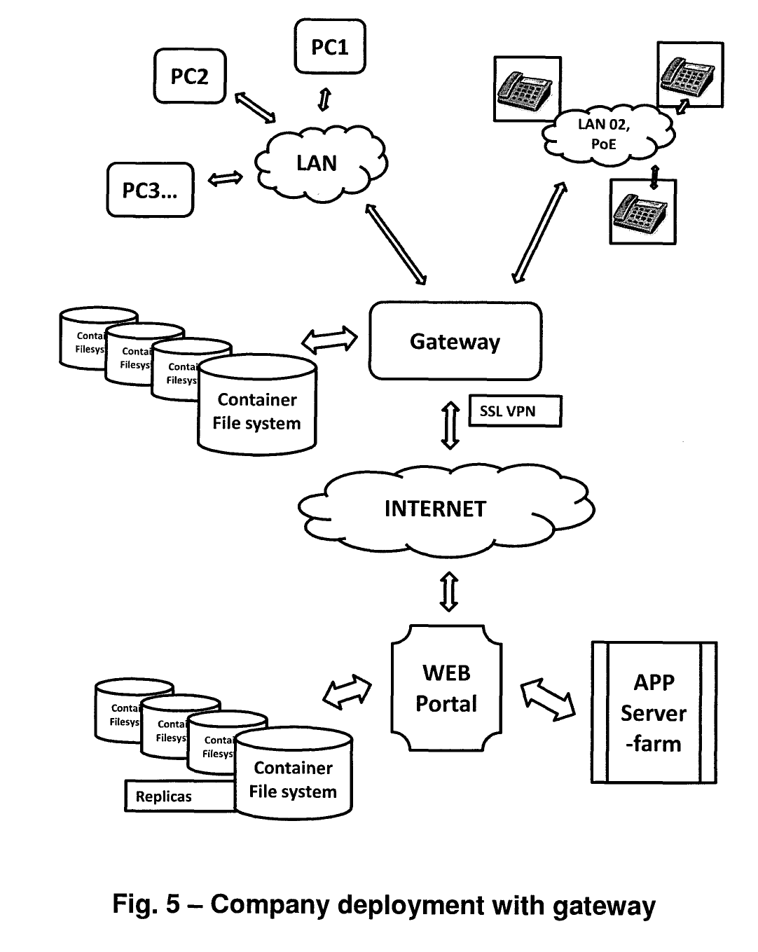

FIG. 5 an exemplary arrangement of the system structure

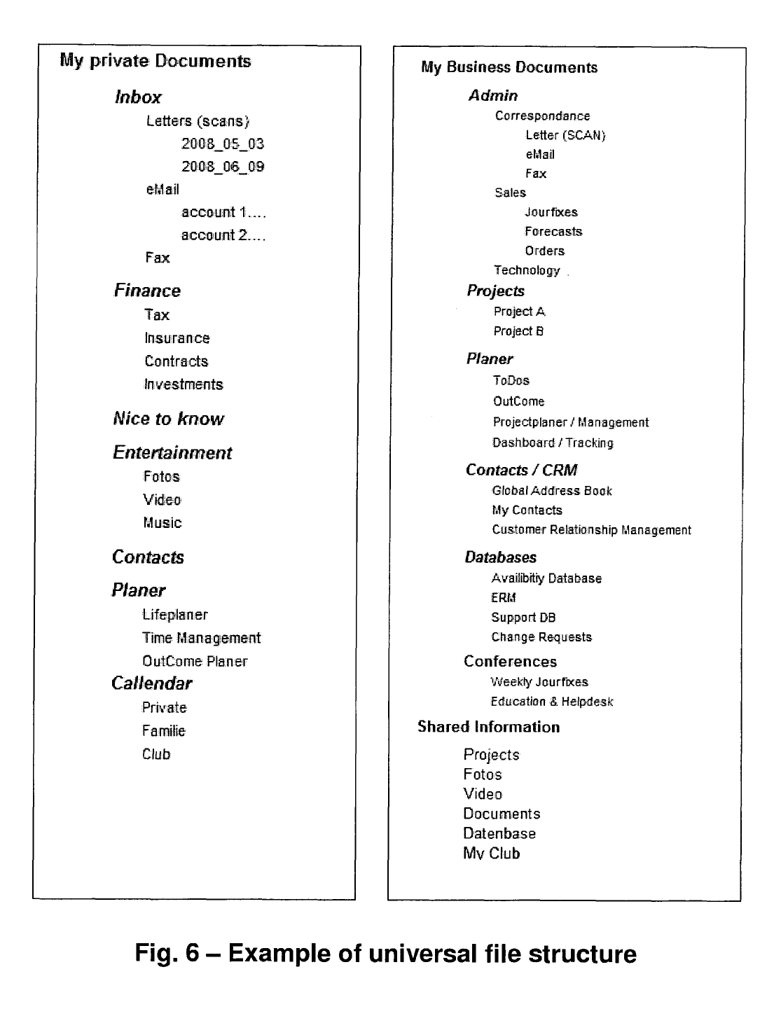

FIG. 6 a schematical demonstration of the demonstration example for the container file system according to the invention

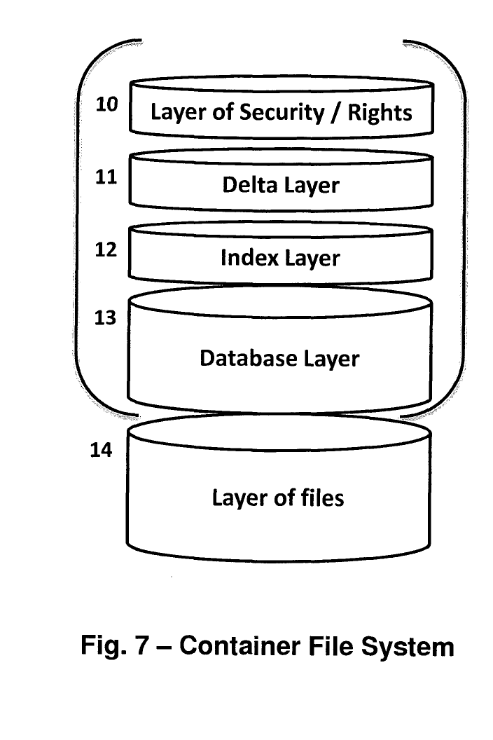

FIG. 7 a demonstration example for the build-up of the container file system according to the invention

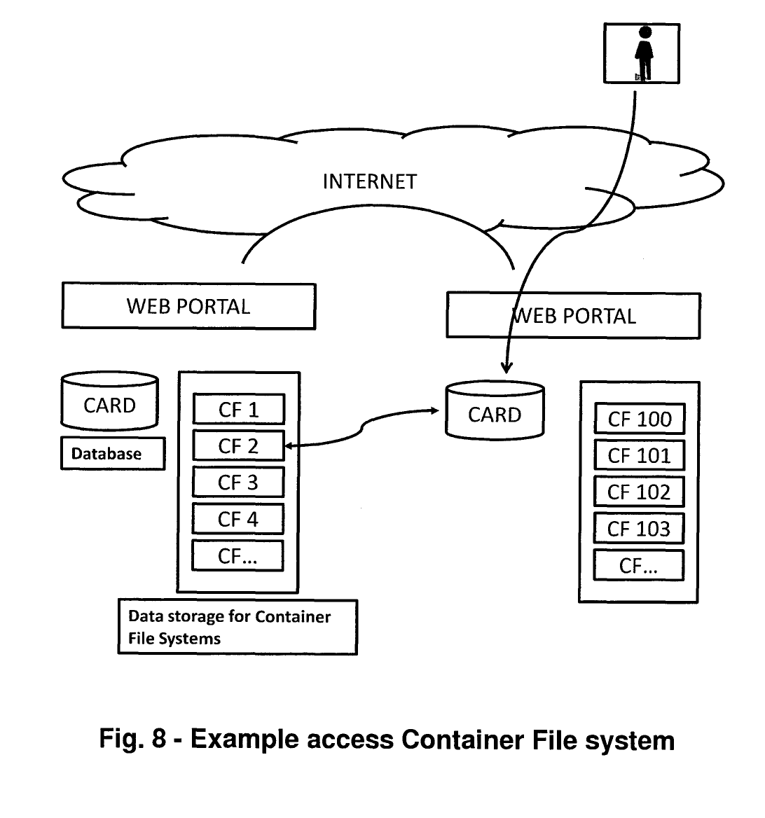

FIG. 8 a further demonstration example for the container file system according to the invention

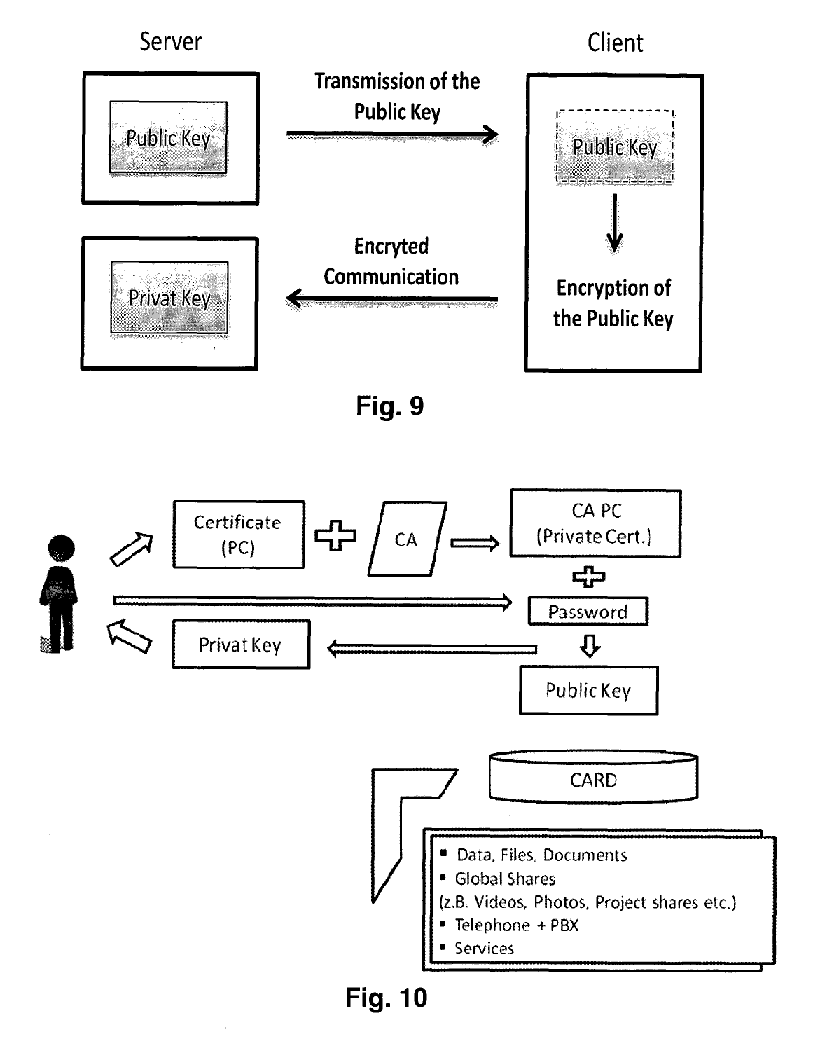

FIG. 9 a schematical demonstration of an demonstration example for a standard SSL-procedure

FIG. 10 a schematical demonstration of an demonstration example for the CARD-rights-distribution

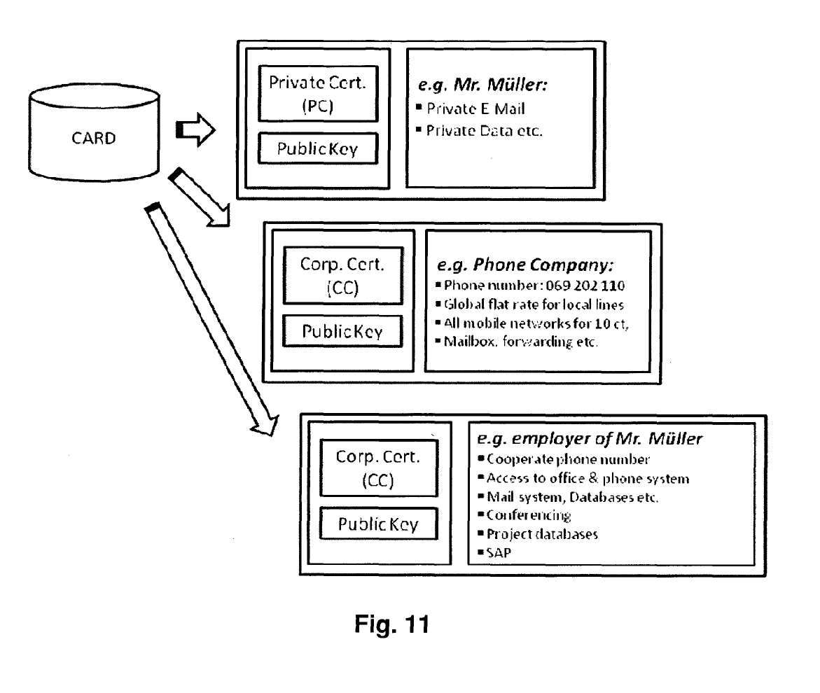

FIG. 11 a schematical demonstration of an demonstration example for the coherence of private and business certificates

FIG. 1 is a schematical demonstration of a demonstration example for the system according to the invention, whereupon the reference sign 1 describes applications and services that are combined advantageously in a way that at least 80% of all the common user requirements can be used with one single user-/operator interface. In addition to this unique combination of applications, an integration of a full-fledged IP-telephone system happens 2. The electronical data processing equipment features an operating system layer 3 with a browser and a client-application. Furthermore, a communication layer 4 is displayed, whereas a data exchange occurs via the Internet SSL (browser) or SSL-VPN (client). All applications and services as well as all telephone installation functionalities will be virtualized, which is indicated through the virtualization layer 5 Moreover occurs a centralized data management via a container file system according to the invention, which, together with a CARD data base, is marked with the reference sign 6. In addition, the displayed system features a very efficient software-based telephone installation 7 that in combination with global VoIP-services 8 features efficient telephone services and installation functions on the standard level of a call center. The reference sign 9 hereby indicates an application server farm that features application programs for the processing of data.

FIG. 2 shows a demonstration example for a system overview of virtualized applications and services. Hereby, all necessary applications and services as well as the hereto necessary technology is continously virtualized and will be provided by a user uniformly. All corresponding functionalities are to be used by a simple browser without any media breaks or incompatibilities. The complete integration and crosslinking brings an enormous improvement of usability (appliance and functionalities). The system functionalities are divided into four logical groups that are named communication and collaboration, office, database and application.

FIG. 3 shows the use of the system according to the invention using a browser, which establishes a connection to the Internet and further, to a web portal via an operating system, which is then contactable with an application server farm as well as with the container file system.

FIG. 4 meanwhile shows the use of the system according to the invention via an operating system which communicates which a local, f. e. on the electronical data processing equipment stored container file system and also may establish a connection to the Internet. The web portal on the other hand is connectable with the application server farm and the container file system which may contain replicas of files that exist in the container file system of the user's electronical data processing installation.

The web portal exhibits both service for data replication of the particular container file systems and the main web application that performs all of the functions as shown in FIG. 2.

Alternatively, the own, on the local PC installed, applications can be used as shown in FIG. 4. Operating system-specific software (FAT-client) enables the user to use the local application as usual by simultaneously routing all data access through this middleware to the container file system according to the invention. Depending on the used operating system, a multitude of data, documents and all kinds of calibrations (f. e. bookmarks, templates, desktop settings and so on) can be saved in various formats in various places of the local container file system. This makes it difficult in the case of a PC change to reconstruct the accustomed work surrounding with a manageable effort. Generally, aside of most of the settings, files and documents get lost as well. The container file system according to the invention produces relief in this matter because even by using the local applications the middleware reroutes all data, documents and settings into the container file system and saves them there.

This container file system according to the invention is viewed by the operating system as an own drive. Data can be stored as usual. Any amount of files can be combined and saved in such a container file system as one data file. This reduces the complexity of a modern operating system to a minimum, meaning one single data file. This data file is not readable without middleware with a valid certificate and password and thereby useless. If a new PC is acquired, merely a connection to the portal via the Internet has to be established. From the portal, the middleware can be installed, which then—in the background—copies the container file system onto the new machine. After the installation of the middleware (FAT-client), all data and settings are available right away. Access occurs via Internet until the local container file system is fully existent. Thereafter, the access occurs only locally, and via Internet only changes are transmitted. This system according to the invention and procedure allow for the maximum work speed by at the same time having a minimal data transfer via the network. Every data transfer occurs through SSL-VPN-tunnels that are protected by the middleware.

This way of connection needs only Port 80 and Port 443 and also works through firewalls and proxy servers as far as those are used in most of the bigger enterprises.

Through this dual approach—web browser and FAT-client—it is possible with the system according to the invention to access the same basic surrounding from every PC with an Internet connection, the surrounding consisting of programs, settings and data inventory. This means that all changes are globally replicated and thereby secure the actuality of all data. Almost all of the functionalities may also be realized on capable smart-phones (example given: iPhone) thanks to the virtualization approach.

The system according to the invention also allows for a direct connection of IP-based phones as an alternative to the software-based telephone functions (Soft-phone). If those are used outside of a company's network, a connection to the portal via an SSL-VPN-client integrated in the phone is possible.

The whole content of the container file system can, through a client and by means of an SSL-VPN-connection, be replicated via the Internet on another storage system. It is hereby possible to worldwide access all data and application through a PC with an Internet connection. By the use of the middleware, all compatible system settings will be carried over. This means that, even with travelling and being outside of the office, the same application programs with the always up-to-date data inventory as well as the whole accustomed communication surrounding (phone, fax, email, conferencing etc.) are available.

The system according to the invention can also be used with efficient mobile phones. Hereby, it is allowed for having the complete data- and communication platform available for twenty four hours and be reachable with only one single phone number (for example as an extension line to the phone installation), this being worldwide possible That way, a mobile phone like, for example, the iPhone can replace a multitude of the currently essential end devices by using the system according to the invention:

A device for office, private and travel life unifies all of the communication- and data transfers.

FIG. 5 shows the system according to the invention being used in a corporate network. Herewith, a gateway is used. This gateway is cluster-able and can be extended over several servers to allow for particular availabilities and scaling possibilities. It unifies not only a capable server-software and storage capacity for the single container file systems but also a full-fledged telephone installation. Moreover, the gateway features pre-defined open interfaces for integration of any applications, data bases etc. (e.g. SAP etc.). According to the invention, all kinds of data and settings in one container file system are combined to one data file. Hereby, all files (files, documents, emails, calendar, data bases etc.) are stored together in one encrypted container file system. Only after the “mounting” of the container file system, an operating system of a PC can access the data as an own drive. All sorts of files, including emails, faxes, letters etc. may now be saved upon the drive as usual. That way, one has a single central storage for all sorts of files in one single encrypted data file. Also, all other users only see a “normal” data drive and can store their data hereunto. The middleware furthermore routes all standard paths such as for example “My documents” automatically to this drive. Besides, the middleware allows for a homogenization of all incompatible data formats. According to the invention, it is now possible to mix everything and to establish a reasonable storage structure without program-specific limitations from a user standpoint.

FIG. 6 shows an example implementation for a structure of the Container File System with incoming and outgoing fax connections, various email accounts, various files and project files, as well as all folders and databases released. For the Container File System, no differences exists between the files, meaning that example emails from the conventional email client, and even the storage structure, may be simply moved by Drag-n-Drop into the Container File System. Alternatively, Outlook's entire OST file can be copied into the data directory. Thereby, all of the Outlook data would always remain synchronized.

If a file (file, email, etc.) were saved then automated indexing without keywords or creation of an index would occur, whereby all index information would be maintained in the central Container File System. The index fields would be suggested but may be changed freely. The database of the Container File System would by default contain a full text field for each file and ease later full text search in this manner. All of the document pages would later be searched automatically for their contents. Contents found would be stored as full text. TIFs, PDFs, etc. would be automatically processed by OCR software, in order to be able to extract the contents. Errors in the OCR software would not be relevant for this procedure, since the extracted text information would ultimately assist with full text searches. However, that the content of each page of any document stored can be found again (Knowledge Management) would be able to be guaranteed in this manner.

Additionally, each file would have the ability to issue rights. This would be able to determine who would receive which type of access to this file. The issuance of right to the individual files could be provide for de-centrally, meaning that each author would possesses the ability to award or prevent other people access to files created by them. An additional level of hierarchy permits the company to centrally provide a system of rights and also limit the individual user's ability to issue rights. The deciding factor is that each person may globally share any file with any other person. An author can allow any person desired to access the files created by them thanks to their authorizations. An email may be sent, for example, with a link. The other person receives access with a simple click. The various levels of authorization, from read to deletion, may be freely selected and may also be time-limited. The author determines how long access is guaranteed. The important thing is that the author, or a higher level in the hierarchy, can withdraw access. A company could, for example, withdraw all access rights in this manner when employees leave. Even a copy of the Container File Systems would immediately be useless, as soon as the access right have been withdrawn. A personalized middleware tool would be required for opening the Container File System, which would be updated upon installation of the access rights of the Container File System and make unauthorized copies unusable forever in this manner. Even the deletion of portions of the Container File System's content would be possible.

In the case of private users, they would naturally possess the highest status in the hierarchy in their Container File System. Normally, each user would only possess one such Container File System. The data file contained therein would contain all data, documents and settings. All data, files, databases, etc. would be centrally stored in an encrypted file on the local hard disk. When using the system according to the invention exclusively through the web browser, there would not be a local data file. Required data and information would be supplied online by a portal server.

The certificate-based system of rights would enable the global distribution of Container File Systems and/or the storage of such with larger service providers. According to the invention, the Container File Systems would also be unreadable under any circumstances by administrators or service providers. A server system would be able to determine which data had been changed and instigate replication. Replication would occur at the bit level, meaning that bits and bytes would be transcribed but without being able to read the actual contents. Each Container File system would possess a unique “fingerprint”. If this were to change, the system according to the invention would attempt to adjust all existing replicates of the Container File System as quickly as possible. Additional details follow as part of the description of the CARD system.

If, for example, a Word document is saved then automated indexing follows, meaning that an attempt is made to generate automated index information from the file. In addition, the middleware according to the invention creates a full text index during system idle time while the Container File System is open by means of OCR, with whose help all of the contents of the files can be accessed later.

The presence of replicates is ensured through the backup process of the system according to the invention. The system always makes N+1 replicates available. Locally stored replicates of the Container File System are created by means of the CARD system described later when international access occurs frequently.

To safeguard against logical errors (e.g. inadvertent deletion), the system according to the invention makes snapshot available. Databases can be frozen in this manner and the deltas make later recovery up to the time point of the snapshot possible.

FIG. 7 shows the schematic structure of a Container File System, which has been divided into five logical partitions. All of the access rights and shares are centrally stored in the Layer 10 Access Rights Data. Additionally, all of the information for data storage has been saved here. This affects files as well as databases and all supplemental features, such as associated indices and information about the replicates and the status of replication. People or groups will receive their access rights to those data and files accordingly to the corresponding certificates. All of the modifications to the Container File System are retained in the Layer 11 Modification Data. If, for example, the client data has been written or deleted then these modifications are retained in the Layer 11 Modification Data. The automated replication mechanism now simply transfers the deltas of the data records, and not the entire data file. This happens at the bit level without being able to read the content. The same applies with globally distributed replicates. Through the Layer 11 Modification Data, it is possible to create access-oriented replicates. If, for example, a specific Container File System is accessed frequently in the USA then the system automatically replicates this Container File System in data center nearby in the USA. This offers the quickest possible global data access. The modifications are ultimately transferred by means of the Layer 11 Modification Data. The Layer 12 Index Data administers all information about supplementary files as well as the index information including full text. All other database features have been reproduced in the Layer 13 Functional Data. This also includes special operator databases. All of the files are stored in the Layer 14 File Data. All upper Layers ultimately receive information about these files.

FIG. 8 shows the CARD database, which has been conceived for the global administration of the Container File System according to the invention. All of the globally distributed Container File Systems, including all of the replicates present and their location have been documented in this database. Furthermore, this database replicates the distribution of additional rights and shares as well as links or references to the associated Container File System from the viewpoint of the rights of the individual Container File Systems. The database itself can, in turn, be distributed worldwide. It is the central component in the otherwise decentralized approach to the solution. Furthermore, the CARD database concentrates the statistical data about sizes, frequency of access, bandwidth, etc. On the basis of this data, the system according to the invention can automatically create and distribute replicates of the files and data files. Next to the increase in the data security and speed of access, the bandwidths of the WAN (Wide Area Network) could be correspondingly minimized. According to the invention, this mechanism can be deployed both by the company internally through their intranet as well as through the Internet.

Also, all data communication occurs in an encrypted manner through the usage of the web browser over port 443 and SSL encryption and through the usage of various clients specific to the operating systems by means of SSL VPN. For this, the client opens an SSL VPN connection to the portal server through port 443. This VPN tunnel guarantees the fully secured means of operation in every environment even through firewalls and proxy servers. It should be noted that the IPSEC procedures most used by leading companies are not appropriate for wireless networks that use dynamic IP addresses, such as GSM/UMTS or ADSL.

FIG. 9 shows an example of the execution of one such standard SSL procedure, where a public key is used for encrypting the data. The encryption occurs by means of the public key while the decryption occurs by means of a private key.

This security concept is based on a certificate-based encryption technology. In this connect, each user creates a unique personal certificate during their initial login to the provider system, where the provider system likewise services as CA (Certification Authority) and may digitally sign the new certificate. After the digital certification, a user may now create a key by means of this certificate and a (longest possible) password. This key consists of one private and one public key. Together with the certificate, this key defines all of the rights, such as, for example, which Container File Systems may be accessed with which rights, or which telephone numbers with which equipment features belong to this person. This private certificate serves as a digital fingerprint and as a unique correlation to one person or to one company. This data is saved centrally in the CARD database. In addition to the public key, additional certificates, e.g. Corporate Certificates, could be also stored. By means of a valid certificate and key with a password, an operator now has global access to data, applications, services and operating system services. For implementation, this solution plans for the expansion of the public key infrastructure (PKI). The public keys are generally published by public key servers. This solution integrates and publishes all of the public keys, including the certificate, centrally through the CARD database system, where even corresponding associations for all of the rights and Container File Systems can be made. In addition, there is also a need to be able to depict the company rights. For employees of a company, a corporate certificate must be presented in addition to their personal certificate in order to be able to crate a corresponding corporate public key. This enables the protection of the intellectual property rights and enables the company to be able to access their employees' data at any time, and to deactivate the employee's certificate upon releasing an employee. If a certificate is completely deactivated, all of the data, telephone services (telephone numbers, trunks, dialing plans, etc.) are likewise deactivated and should no longer be used. Any number of dedicated rights may be issued and revoked through the CARD database. Access to data and services may only occur in combination with a valid certificate and public key. An employee of a company receives a corporate certificate, which enables them to act on the behalf of the company, send emails, make telephone calls, etc. By means of this new technology, a company is capable of protecting their interests through corresponding issuance and revocation of rights, even in the event that an employee or competitor wrongfully purloins company information. In comparison, a private individual receives unlimited rights to their private certificate. Also, it may only be deleted by this individual through the usage of their private password. However, corporate certificates provide considerably expanded capabilities for the depiction of services, operating system services, etc.

Illustration 9 shows a schematic representation of an example execution of the creation of CARD rights. For this, a person requests a private certificate. The certificate authority then issues a signature. The person receives a signed private certificate. By means of a password, the person may now create private and public keys and access the system. The public key primarily services for hybridized encryption of all data communications. This includes web conferences and telephony, in addition to email communications. The person can now create Container File Systems, email accounts, telephone connections, etc. issue shares and cooperatively use shares.

FIG. 10 shows an example execution for the interrelation between private and corporate certificates, where this example links the corporate certificates by means of Mr. Mueller's private certificate. Mr. Mueller's personal fingerprint is his private certificate with associated public key. All of his private data bear his special private signature. If, for example, Mr. Mueller would like to publish his private video, he may do this, for example, by simply right-clicking the mouse on the share. He simply adds the desired people or group and his videos are immediately retrievable there. By issuing a right, Mr. Mueller can prevent the ability to copy his video and remains the owner at all times. If he would like to stop the publication, he can do this at any time and in the blink of an eye, his videos are no longer available, anywhere in the world and without exception. All data communication is likewise encrypted by means of his public key. Mr. Mueller has concluded a contract with a telephone company. As long as this contract exists and he pays his invoices, the corporate certificate from the telephone company enables him to use a certain telephone number, as well as use corresponding dialing plans and make calls. If compensation should be paid, an invoice is produced on this basis in Mr. Mueller's home country. This is of particular interest for international business travelers. Mr. Mueller possesses an additional corporate certificate. By means of this certificate, Mr. Mueller can send company email, access company data, make telephone calls using the company telephone system, etc. By means of collaboration, he supports an international web conference with company recognition and mutual information sharing for project data. By means of the project tracking tool's dashboard, he can immediately see which person has not completed their assured tasks by the deadlines. Additionally, automatic notifications are sent to the team leader. All of the activities have been signed using the company certificate; even if an external service provider or company is involved, all of the rights remain protected. Upon the dissolution of the project group, the data is retained against unauthorized access.

The examples of execution described by the figures are for explanatory purposes and other possibilities do exist.

### REFERENCE SIGNS LIST

1 Applications and Services
2 Full featured telephone system
3 Operation system layer
4 Communication layer
5 Virtualization layer
6 Container file system and CARD Database
7 Software based Telephone Device
8 Globally accessible VoIP Services
9 Application server farm
10 Layer of access rights
11 Delta data layer
12 Index data layer
13 Data layer of functionalities
14 Data layer of files and documents

1. System for the administration of files by use of a plurality of data processing installations linked together through a network, characterized in that a data processing installation, in the plurality of data processing installations, features a user-related container file system whose function is based upon having files of the particular user combined to one single data file, wherein the access to the files in the data files occurs depending on access rights and wherein an automatic comparison of the data files with a system-immanent replica is performed;

2. System according to claim 1, characterized in that after detecting a difference between the replica and the data file, an automatic adjustment of the older version of the data file to the younger version of the same is performed.

3. System according to claim 2, characterized in that the automatic adjustment of the older version of the data file to the younger version occurs by merely transmitting the difference-corresponding change of the data file for the adjustment of the older version of the data file via the network.

4. System according to claim 1, characterized in that the automatic comparison occurs on the bit-level.

5. System according to claim 1, characterized in that the content of the datafiles is encrypted.

6. System according to claim 1, characterized in that an application server exists which is connectable with the electronical application programs through the network, on which application programs for the editing of files are saved.

7. System according to claim 6, characterized in that the application programs are virtualized and partially combined with one another.

8. System according to claim 1, characterized in that a software-based telephone installation exists, which is combined with the application programs and global VoIP-Services.

9. System according to claim 8, characterized in that the functionalities of the telephone installation are virtualized.

10. System according to claim 1, characterized in that a full-fledged telephone installation exists that is connectable with an electronically data processing equipment.

11. System according to claim 1, characterized in that the container file system is built up in multilayers wherein an access-rights-data-layer, a change-data-layer, an index-data-layer, a function-data-layer and/or a document-data-layer are intended.

12. System according to claim 1, characterized in that a database for access rights exists, which through the network is connectable to the electronical data processing equipment.

13. Procedure for the administration of files by using a system with data processing equipment that is connected with each other through a network, characterized in that files of a particular user are concentrated into one single data file in a user-related container file system of a data processing equipment, wherein the access to the files of the data files occurs depending on access rights and wherein an automatic comparison of the data files with a replica within the system is being performed.

14. Procedure according to claim 13, characterized in that after a detection of a difference between the replica and the data file, an automatic adjustment of the older version to the younger version takes place.

15. Procedure according to claim 14, characterized in that the automatic adjustment of the older version of the data files to the younger version of the same occurs by simply transferring the difference corresponding to the change in order to adjust the older version of the datafile, this being performed through the network.

16. Procedure according to claim 13, characterized in that the automatic comparison occurs on the bit-level.

17. Procedure according to claim 13, characterized in that the editing of the files is being done by means of an application program that is situated on a connectable application server, the very server being connected through the network with an electronical data processing equipment.

18. Procedure according to claim 17, characterized in that the application programs are virtualized and partially connected to each other.

19. Procedure according to claim 13, characterized in that the administration of files occurs based on file-specific index attributes which are extracted from the files.

20. Procedure according to claim 19, characterized in that the index attributes are generated automatically and/or entered manually.

21. Procedure according to claim 13, characterized in that the digital documents are encrypted automatically.

22. Procedure according to claim 13, characterized in that file-specific access rights are distributed.
